(19) United States
(12) Patent Application Publication
(10) Pub. No.: US 2007/0060104 A1
(43) Pub. Date: Mar. 15, 2007

(54) Method and apparatus for improving communication security

(75) Inventors: Nikhil Marathe, Chicago, IL (US); Wayne Heinmiller, Elgin, IL (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/196,615

(22) Filed: Aug. 3, 2005

(51) Int. Cl. H04M 3/16

(52) U.S. Cl. 455/410

(57) ABSTRACT

Each of a terminal (102) and an access point (104) has a communication system (200) having a transceiver (202), and a processor (204). The processor is programmed to interleave (302) data between two or more packet streams, encrypt (306) each packet stream, and transmit (310) each encrypted packet stream in distinct communication channels.

### FIELD OF THE INVENTION

This invention relates generally to securing data exchanges, and more particularly to a method and apparatus for improving communication security.

### BACKGROUND OF THE INVENTION

The ubiquity of communication systems has made it very simple to the common consumer to stay in touch nearly anywhere at anytime. With this expansive growth, however, the security of such communications has become a rising concern. To protect communications (either on wired or wireless means), encryption methods have been deployed widely. Although this has substantially improved security, encryption methods have been known to be broken into for the purpose of stealing proprietary information such as credit card information, or by the common hacker for the purposes of changing or destroying information as a form of cyber-terrorism.

A need therefore arises for a method and apparatus to improve communication security.

### BRIEF DESCRIPTION OF THE DRAWINGS

FIG. 1 is block diagram of a terminal coupled to an access point for exchanging secure messages according to an embodiment of the present invention;

FIG. 2 is block diagram of a communication system in each of the terminal and the access point according to an embodiment of the present invention; and

FIG. 3 depicts a flowchart of a method operating in the communication system according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

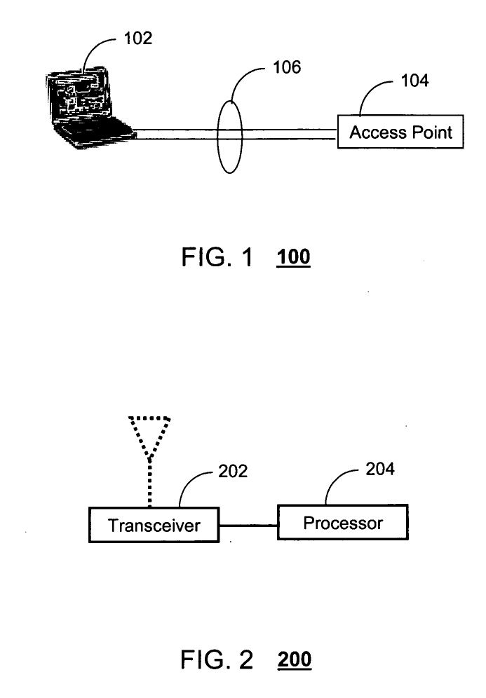

FIG. 1 is block diagram 100 of a terminal 102 coupled to an access point 104 for exchanging secure messages according to an embodiment of the present invention. In the present context, a terminal 102 can comprise any computing device such as a laptop computer, a desktop computer, or a Personal Digital Assistant, any of which incorporates a communication system 200 (see FIG. 2) for exchanging secure messages with the access point 104 by wired or wireless means 106. The access point 104 can represent any conventional point of entry into a communication system (e.g., DSL—Digital Subscriber Line, Cable, ISDN—Integrated Services Digital Network, Ethernet, or cellular networks, just to mention a few). Like the terminal 102, the access point 104 incorporates a communication system 200 as shown in FIG. 2 to exchange secured messages therebetween.

The communication system 200 comprises a transceiver 202 and a processor 204. The transceiver 202 can use conventional communications technology for exchanging analog and/or digital messages on a wired and/or wireless interface. In the case of wired communications, the transceiver 202 can utilize any conventional communications protocol such as, for example, Ethernet. For wireless communications, the transceiver 202 can utilize any conventional communications protocol such as, for example, IEEE 802.11 a/b/g, Bluetooth, cellular protocols such as CDMA 1X, EV/DO, GSM, GPRS, TDMA, Edge, and so on.

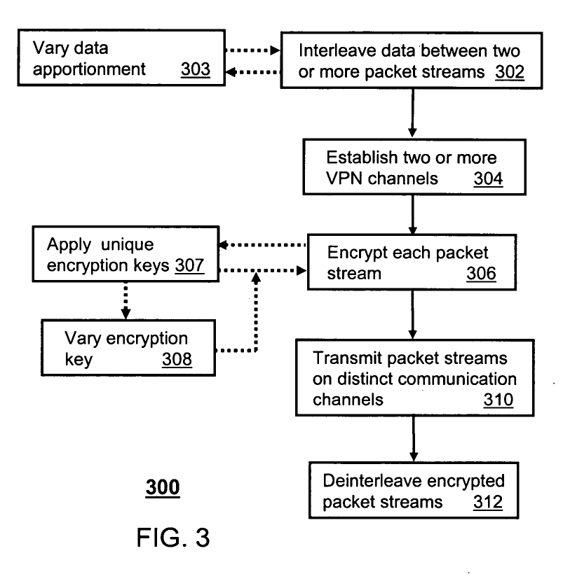

The processor 204 can utilize conventional computing technology such as a microprocessor and/or DSP (Digital Signal Processor) with associated storage such as a mass storage media disk drive, ROM, RAM, DRAM, SRAM, Flash and/or other like devices. The processor 204 controls operations of the transceiver 202 and performs signal processing on secure messages according to an embodiment of the present invention illustrated in FIG. 3.

FIG. 3 depicts a flowchart of a method 300 operating in the communication system 200 of the terminal 102 and access point 104, respectively, according to an embodiment of the present invention. Method 300 begins with step 302 in which the communication system 200 interleaves data into two or more packet streams. In the present context, interleaving means a random or pseudo-random division of contiguous data between packet streams destined to be carried by distinct communication channels. Referring back to FIG. 1, the communication means 106 shows two lines. These lines can represent logical or physical connections for transmitting packet streams. In prior art systems, a secure channel such as a virtual private network (VPN) transforms contiguous data into a secured packet stream on a single channel. In the present invention, packet streams are interleaved in separate logical or physical channels to prevent tampering or monitoring of secure messages.

In step 304 two or more VPN channels can be established to carry the interleaved packet streams created in step 302. Each packet stream is encrypted in step 306 and transmitted in step 310 on distinct VPN channels. In step 312, the encrypted packet streams are deinterleaved at either the terminal 102 or access point 104 and decrypted for processing. Deinterleaving can take place between end points of communication (e.g., terminal to terminal, terminal to access point, or access point to access point).

By interleaving data between VPN channels, it becomes exceedingly difficult for an intruder to monitor information transmitted between the terminal 102 and access point 104. In particular, the intruder has no way of knowing what interleaving algorithm is in use. For instance, the terminal 102 and access point 104 can have synchronized clocks which allows them to interleave data between VPN channels in a pseudo-random manner. Additionally, any number of VPN channels can be created to augment the interleaving process.

Supplemental embodiments can also be applied to further increase the difficulty of monitoring or penetrating a secure communication. For example, in step 303 the apportionment of data between packet streams can be varied. This variance can be periodic or pseudo-random. As such, an intruder would have a very difficult time deciphering information captured on one VPN channel, not to mention more. Moreover, in step 307 unique and distinct encryption keys can be applied to each packet stream, and over the course of time said keys can be varied in step 308 so as randomize encryption on the VPN channels.

As these embodiments are applied, it becomes exceedingly difficult for intruders (“hackers”) to break through a secure communication link operating according to the present invention.

It should be evident by now that the present invention can be realized in hardware, software, or a combination of hardware and software. Moreover, the present invention can be realized in a centralized fashion, or in a distributed fashion where different elements are spread across several interconnected processors. Thus, any kind of computing device or other apparatus adapted for carrying out method 300 described above is suitable for the present invention.

It should be also evident that the present invention may be used for many applications. Thus, although the description is made for particular arrangements and methods, the intent and concept of the invention is suitable and applicable to other arrangements and applications not described herein. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

A software program in the present context means any expression, in any language, code or notation, of a set of instructions intended to cause a system having an information processing capability to perform a particular function either directly or after either or both of the following: a) conversion to another language, code or notation; b) reproduction in a different material form.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art that are applicable to the present invention. Such standards are periodically superseded by faster or more efficient equivalents having essentially the same functions. Accordingly, replacement standards and protocols having the same functions are considered equivalents.

The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A method for transmitting secure data between a terminal and an access point, comprising the steps of:
interleaving data between two or more packet streams;
encrypting each packet stream; and
transmitting each encrypted packet stream in distinct communication channels.

2. The method of claim 1, wherein each packet stream represents a virtual private network (VPN).

3. The method of claim 1, wherein the distinct communication channels comprise at least one among wired and wireless communication channels.

4. The method of claim 1, wherein each packet stream utilizes a unique encryption key.

5. The method of claim 4, comprising the step of varying the unique encryption key.

6. The method of claim 1, comprising the step of varying the apportionment of data between the two or more packet streams.

7. The method of claim 1, comprising the step of deinterleaving the encrypted packet streams at one among the terminal and the access point.

8. In each of a terminal and an access point a computer-readable storage medium, comprising computer instructions for:
interleaving data to be exchanged between a terminal and an access point into two or more packet streams;
encrypting each packet stream; and
transmitting each encrypted packet stream in distinct communication channels.

9. The storage mediums of claim 8, comprising computer instructions for establishing a virtual private network (VPN) at each communication channel.

10. The storage mediums of claim 8, comprising computer instructions for exchanging the encrypted packet streams in distinct communication channels comprising at least one among wired and wireless communication channels.

11. The storage mediums of claim 8, comprising computer instructions for applying on each packet stream a unique encryption key.

12. The storage mediums of claim 11, comprising the step of varying the unique encryption key.

13. The storage mediums of claim 8, comprising computer instructions for varying the apportionment of data between the two or more packet streams.

14. The storage mediums of claim 8, comprising computer instructions for deinterleaving the encrypted packet streams at one among the terminal and the access point.

15. Each of a terminal and an access point has a communication system, comprising:
a transceiver; and
a processor, wherein the processor is programmed to:
interleave data to be exchanged between a terminal and an access point into two or more packet streams;
encrypt each packet stream; and
transmit each encrypted packet stream in distinct communication channels.

16. The communication system of claim 15, wherein the processor is programmed to establish a virtual private network (VPN) at each communication channel.

17. The communication system of claim 15, wherein the processor is programmed to exchange the encrypted packet streams in distinct communication channels comprising at least one among wired and wireless communication channels.

18. The communication system of claim 15, wherein the processor is programmed to:
apply on each packet stream a unique encryption key; and
vary the unique encryption key.

19. The communication system of claim 15, wherein the processor is programmed to vary the apportionment of data between the two or more packet streams.

20. The communication system of claim 15, wherein the processor is programmed to deinterleave the encrypted packet streams at one among the terminal and the access point.
